(19) United States
(12) Patent Application Publication
(10) Pub. No.: US 2009/0297764 A1
(43) Pub. Date: Dec. 3, 2009

(54) Stablized Low-Microcracked Ceramic Honeycombs And Methods Thereof

(76) Inventors: Douglas Munroe Beall, Painted Post, NY (US); George Halsey Beall, Big Flats, NY (US)

Correspondence Address: CORNING INCORPORATED, SP-TI-3-1, CORNING, NY, 14831, US

(21) Appl. No.: 12/473,965

(22) Filed: May 28, 2009

Related U.S. Application Data
(60) Provisional application No. 61/130,403, filed on May 30, 2008.

(51) Int. Cl. C04B 35/04; C04B 38/02; B32B 3/12; B29C 67/24

(52) U.S. Cl. 428/116; 501/118; 501/80; 264/43

(57) ABSTRACT

Disclosed are stabilized, high-porosity cordierite honeycomb substrates having little or no microcracking, and a high thermal shock resistance. The porous ceramic honeycomb substrates generally comprise a primary cordierite ceramic phase as defined herein. Also disclosed are methods for making and using the cordierite substrates.

### CROSS-REFERENCE TO RELATED APPLICATIONS

This application claims the benefit of priority to U.S. provisional application No. 61/130,403, filed on May 30, 2008.

### BACKGROUND

The disclosure relates to porous honeycomb ceramics and methods of making, and more particularly to porous cordierite honeycomb ceramics useful in catalytic converters and particulate filters, such as for engine exhaust after-treatment.

### SUMMARY

The disclosure provides a high-porosity cordierite honeycomb substrate or diesel particulate filters having little or no microcracking and that can maintain a high thermal shock resistance even with an increased coefficient of thermal expansion that is expected in the absence of microcracking.

The disclosure provides honeycomb bodies that have improved strength that makes them excellent choices for the fabrication of catalytic converter substrates or diesel particulate filters (DPFs) having very thin walls, together with, if desired, low cell densities for reduced back pressure and reduced thermal mass (faster light-off). The improved strength can also enable the manufacture of ceramic bodies having higher porosities for use in converter substrates and DPFs for further reduction in thermal mass or for storage of high amounts of catalyst (such as for SCR or 4-way catalyzed DPFs) while maintaining adequate strength.

In embodiments, the porous cordierite ceramic honeycomb bodies exhibit a high thermal shock resistance and little or no microcracking even after prolonged exposure to high temperature. More specifically, the ceramic honeycomb bodies exhibit a porosity of at least 40%; a thermal shock parameter defined as (MOR_{25° C.}/E_{25° C.})(CTE_{500-900° C})⁻¹ of at least 450° C.; and at least one of an elastic modulus ratio E_{900° C.}/E_{25° C.} of ≦0.99 and a microcrack parameter Nb³≦0.07, as measured after exposure to 850° C. for at least 80 hours in air. A porosity ≧40% has been found to be beneficial for a higher ratio of MOR_{25° C.}/E_{25° C.}, which can provide improved thermal shock resistance in a non-microcracked cordierite ceramic body. The minimum value of (MOR_{25° C.}/E_{25° C.})(CTE_{500-900° C.})⁻¹ of at least 450° C. further ensures that the honeycomb body will have good thermal shock resistance.

Among several advantages provided by various embodiments, the porous honeycomb exhibit much higher strengths for a given % porosity and pore size distribution than those of more highly microcracked cordierite ceramics. The reduced microcracking may obviate the need for a passivation step prior to catalyzation, especially for DPFs, because there are few or no microcracks into which the washcoat/catalyst system can penetrate. This may allow more latitude in the design of the catalysts system and washcoating process. The improved stability against microcrack propagation after exposure to high temperatures exhibited by the inventive bodies reduces the risk of accumulation of ash or soot in microcracks during use, which could increase CTE and increase elastic modulus, thereby reducing thermal shock resistance when the body is used as a diesel particulate filter. The improved stability against microcrack propagation can also allow a high strength of the porous filter or substrate to be maintained throughout its lifetime. The increased strength and improved lifetime stability enable fabrication of converter substrates having very thin walls and/or low cell densities for reduced back pressure and reduced thermal mass for either faster light-off or reduction in the amount of precious metal catalyst, higher porosities and for further reduction in thermal mass, and higher porosities for storage of large amounts of catalyst (such as for SCR) while maintaining high strength. The increased strength and improved lifetime stability also permit higher porosities in DPFs for higher catalyst loadings or reduced wall thickness while maintaining low pressure drop and high strength.

In accordance with another embodiment, a batch composition is provided for forming a porous ceramic honeycomb body. The batch composition generally comprises a cordierite forming inorganic powder batch mixture comprising a magnesium source; an aluminum source; a silicon source; and a strontium oxide source. The batch composition further comprises an organic binder and a liquid vehicle.

Still further, in other embodiments of the disclosure, methods are provided for forming porous cordierite ceramic honeycomb bodies disclosed herein. The method generally comprise mixing inorganic raw materials, an organic binder, and a liquid vehicle to form a plasticized batch, forming a green body from the plasticized batch, drying the green body, and firing the body to provide the cordierite ceramic structure.

Additional embodiments of the disclosure will be set forth, in part, in the detailed description, and any claims which follow, or can be learned by practice of the disclosure. The foregoing general description and the following detailed description are exemplary and explanatory only and are not restrictive.

### BRIEF DESCRIPTION OF THE DRAWINGS

The accompanying drawings illustrate certain embodiments of the disclosure.

FIG. 1 is an isometric view of porous honeycomb substrate.

FIG. 2 is an isometric view of porous honeycomb filter.

### DETAILED DESCRIPTION

Various embodiments of the disclosure will be described in detail with reference to drawings, if any. Reference to various embodiments does not limit the scope of the disclosure, which is limited only by the scope of the claims attached hereto. Additionally, any examples set forth in this specification are not limiting and merely set forth some of the many possible embodiments for the claimed invention.

Disclosed are materials, compounds, compositions, and components that can be used for, can be used in conjunction with, can be used in preparation for, or are products of the disclosed method and compositions. These and other materials are disclosed herein, and when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all embodiments of this disclosure including any components of the compositions and steps in methods of making and using the disclosed compositions. Thus, if there are a variety of additional steps that can be performed each of these additional steps can be performed with any specific embodiment or combination of embodiments of the disclosed methods, and that each such combination is specifically contemplated and should be considered disclosed.

Porous cordierite ceramic honeycomb structures having high thermal shock resistance are useful for pollution control devices such as catalytic converter substrates, SCR substrates, and certain diesel particulate filters (DPFs). In these applications, porosity in the substrate provides a means to “anchor” the washcoat or catalyst onto the surface, or within the interior, of the channel walls, and serves to filter fine particulates from the exhaust gas in the case of DPFs. Historically, high thermal shock resistance in cordierite honeycomb ceramics has been achieved by maintaining a low coefficient of thermal expansion (CTE) which, in turn, is attained through microcracking and textural orientation of the cordierite crystals with their negative thermal expansion z-axes (also referred to as c-axes) oriented within the plane of the wall of the honeycomb. In a further effort to maintain a low coefficient of thermal expansion, previous approaches have also emphasized the use of high-purity raw materials low in sodium, potassium, calcium, iron, etc., in order to minimize the presence of secondary phases, especially a glass phase.

Recent trends in exhaust after-treatment for gasoline engines have placed greater demands on the catalytic converters. Specifically, converters with lower mass per unit volume are desired because such converters will heat up faster and begin catalytic conversion of the exhaust sooner, thereby resulting in lower overall emission of pollutants during a driving cycle. Lower mass can be achieved by any combination of lower cell density, thinner walls, or higher porosity, all of which may reduce the strength of the converter substrate. Achieving high strength in low-mass cordierite honeycombs remains a challenge because the presence of microcracks, which are necessary for very low CTE, may also reduce the strength of the ceramic. In DPFs, higher porosity is also often desired in cases where the DPF is catalyzed. This higher porosity similarly may lower the strength of the DPF.

A second challenge faced by catalyzed substrates or DPFs comprised of a microcracked cordierite ceramic is penetration of very fine catalyst washcoat particles into the microcracks within the cordierite matrix, or precipitation of dissolved components from the washcoat and catalyst system in the microcracks. In DPFs, it is also possible for ash or soot particles to enter the microcracks. The presence of particles within the microcracks may interfere with the closing of the microcracks during heating, essentially pillaring the cracks open. This may result in an increase in the coefficient of thermal expansion (CTE) and may also cause an increase in elastic modulus (E), both factors which may contribute to a reduced thermal shock resistance.

Although previous efforts at improving thermal shock resistance have focused on reducing the coefficient of thermal expansion, the thermal shock resistance of a ceramic material can also be improved by increasing the ratio of the strength (such as measured by the modulus of rupture) to Young's elastic modulus, MOR/E. The quantity MOR/E is also known as the strain tolerance of the ceramic.

In embodiments, the disclosure provides a high-porosity cordierite honeycomb substrate or DPF that exhibits little or no microcracking and maintains a high thermal shock resistance even with an increase in the coefficient of thermal expansion that occurs in the absence of microcracking. Such a substrate exhibits improved strength, and also possesses a thermal shock resistance that is less sensitive to the presence of the washcoat and catalyst. In still further embodiments, the cordierite honeycomb substrate or DPF continues to exhibit little or no microcracking and maintains a relatively high thermal shock resistance after prolonged exposure to high temperatures or corrosive conditions.

As used herein, “include,” “includes,” or like terms means including but not limited to.

The singular forms “a,” “an,” and “the” include plural referents unless the context clearly dictates otherwise. Thus, for example, reference to a “component” includes embodiments having two or more such components, unless the context clearly indicates otherwise.

The term “optional” or “optionally” means that the subsequently described event or circumstance can or cannot occur, and that the description includes instances where the event or circumstance occurs and instances where it does not. For example, the phrase “optional component” means that the component can or can not be present and that the disclosure includes both embodiments including and excluding the component.

Ranges can be expressed herein as from “about” one particular value, to “about” another particular value, or “about” both values. When such a range is expressed, another embodiment includes from the one particular value, to another particular value, or both. Similarly, when values are expressed as approximations, by use of the antecedent “about,” the particular value forms another embodiment. The endpoints of each of the ranges are significant both in relation to the other endpoint, and independently of the other endpoint.

“Weight percent,” “wt. %,” “percent by weight” or like terms referring to, for example, a component, unless specifically stated to the contrary, refers to the ratio of the weight of the component to the total weight of the composition in which the component is included, expressed as a percentage.

In embodiments, the porous ceramic honeycomb bodies exhibit relatively high levels of porosity. For example, the ceramic honeycomb bodies of the disclosure can have a total porosity % P≧40% such as a total porosity (% P) of the porous body of at least 45%, at least 50%, and even at least 55%. Additionally or alternatively, the ceramic honeycomb bodies of the disclosure can have a total porosity % P≧46%, % P≧48%, % P≧52%, % P≧54%, % P≧56%, or even % P≧58%. In embodiments, the ceramic honeycomb bodies of the disclosure can even have a total porosity % P≧60% or even % P≧65%.

The durability of the disclosed ceramic articles under thermal shock conditions can be characterized by the calculation of a thermal shock parameter (TSP). More specifically, TSP is an indicator of the maximum temperature difference a body can withstand without fracturing when the coolest region of the body is at about 500° C. Thus, for example, a calculated TSP of about 558° C. implies that the maximum temperature at some position within the honeycomb body must not exceed 1058° C. when the coolest temperature at some other location within the body is 500° C. The thermal shock parameter is calculated according to the equation TSP=(MOR_{25° C.}/E_{25° C.})(CTE_{500-900° C.})⁻¹ wherein MOR_{25° C.} is the modulus of rupture strength at 25° C., E_{25° C.} is the Young's elastic modulus at 25° C., and CTE_{500-900° C.} is the mean thermal expansion coefficient from 500° C. to 900° C. as measured during heating of a honeycomb sample parallel to the length of the channels.

The modulus of rupture, MOR, is measured by the four-point method on a cellular bar, such as either about 0.5×1.0×5.0 inches or about 0.25×0.5×2.75 inches, whose length is parallel to the channels of the honeycomb. The MOR is a measure of the flexural strength of the honeycomb body. A high value of MOR is desired because this corresponds to greater mechanical durability of the body and higher thermal durability and thermal shock resistance. A high value of MOR also yields higher values for the thermal shock parameter, (MOR_{25° C.}/E_{25° C.}) (CTE_{500-900° C.})⁻¹ and strain tolerance, (MOR_{25° C.}/E_{25° C.}).

The elastic modulus (Young's modulus), E, is measured by a sonic resonance technique either along the axial direction of a 0.5×1.0×5.0 inch honeycomb specimen or along the length of a 0.25×5.0 inch cylindrical rod. The elastic modulus is a measure of the rigidity of the body. A low value of E is desired because this corresponds to greater flexibility of the body and higher thermal durability and thermal shock resistance. A low value of E also yields higher values for the thermal shock parameter, (MOR_{25° C.}/E_{25° C.})(CTE_{500-900° C.})⁻¹. The value E_{25° C.} is the elastic modulus of the specimen at or near room temperature before heating of the specimen. E_{900° C.} is the elastic modulus of the specimen measured at 900° C. during heating of the specimen.

The coefficient of thermal expansion, CTE, is measured by dilatometry along the axial direction of the specimen, which is the direction parallel to the lengths of the honeycomb channels. As noted above, the value of CTE_{500-900° C.} is the mean coefficient of thermal expansion from 500 to 900° C. Similarly, the value of CTE_{25-800° C.} is the mean coefficient of thermal expansion from 25 to 800° C., and the value of CTE_{200-1000° C.} is the mean coefficient of thermal expansion from 200 to 1000° C., all as measured during heating of the sample. A low value of CTE is desired for high thermal durability and thermal shock resistance. A low value of CTE yields higher values for the thermal shock parameter, (MOR_{25° C.}/E_{25° C.})(CTE_{500-900° C.})⁻¹.

In embodiments of the disclosure, it is preferred that the thermal shock parameter values of the honeycomb bodies be TSP≧450° C., TSP≧500° C., TSP≧550° C., and even TSP≧600° C. In other embodiments, the thermal shock parameter values can be TSP≧700° C., TSP≧750° C., TSP≧800° C., and even TSP≧900° C. From these exemplary TSP values in embodiments of the disclosure, the Thermal Shock Limit (TSL) of ceramic honeycomb bodies can be calculated. As noted above, the thermal shock limit is conventionally considered to be the maximum temperature to which the center of the body can be heated when the surface of the body is 500° C., without suffering cracking damage. TSL can be estimated by adding 500° C. to the value of Thermal Shock Parameter (TSP) as according to TSL=TSP+500° C.

In embodiments, a large proportion of highly interconnected pores can have a narrow pore size distribution and may contribute to the relatively high strain tolerance and high TSP values obtained. High pore interconnectivity in these low microcracked ceramics has the effect of reducing elastic modulus values to a greater extent than MOR values. Thus, the strain tolerance (MOR_{25° C.}/E_{25° C.}) also denoted (MOR/E)_{25° C.}, upon which the TSP value depends, can be favorably impacted by the amount of porosity of these low microcracked ceramics. In embodiments, a relatively high strain tolerance or ratio of (MOR/E)_{25° C.} is provided, where (MOR/E)_{25° C.}≧0.12%, (MOR/E)_{25° C.}≧0.13%, (MOR/E)_{25° C.}≧0.14%, (MOR/E)_{25° C.}≧0.15%, (MOR/E)_{25° C.}≧0.16%, (MOR/E)_{25° C.}≧0.17%, (MOR/E)_{25° C.}≧0.18%, (MOR/E)_{25° C.}≧0.19%, or even (MOR/E)_{25° C.} ≧0.20%.

The presence of a residual glass phase in the inventive ceramic bodies can serve to further reduce the microcracking and increase the strain tolerance (MOR/E) of the body, and thereby increase its thermal shock resistance. This is in contrast to the teachings of previous studies of highly microcracked cordierite ceramic bodies in which the amount of glass phase is sought to be minimized. Thus, in embodiments of the disclosure, the porous cordierite ceramic honeycomb body can contain a residual glass phase comprised of one or more metal oxides other than the MgO, Al₂O₃, and SiO₂ metal oxides found in cordierite. These metal oxides are preferably selected from the group comprised of alkali metal oxides, alkaline earth metal oxides other than magnesium, rare earth metal oxides including yttrium oxide and lanthanum oxide, and transition metal oxides including those of iron, titanium, manganese, and zinc. The metal oxides may also comprise those that serve at “network” formers within the atomic structure of a residual glass phase, such as boron oxide and phosphorus oxide. In some embodiments, the porous cordierite ceramic honeycomb body comprises at least 1.0 wt % total metal oxides other than MgO, Al₂O₃, and SiO₂. In alternative or additional embodiments, the sum of the metal oxides exclusive of MgO, Al₂O₃, and SiO₂ is more preferably at least 1.5 wt %, at least 2.0 wt %, and even at least 3.0 wt %.

In still further embodiments of the disclosure, the presence of strontium oxide as at least a portion of a residual glass phase can act to stabilize a non-microcracked ceramic matrix against opening of microcracks after subsequent heat treatments. To that end, without wishing to be bound by theory, it is thought that the presence of an intergranular secondary glass phase can be effective in relieving microstresses arising during cooling due to mis-aligned groups of neighboring cordierite crystals (domains) due to the thermal expansion anisotropy of cordierite. These microstresses can result in the opening of microcracks upon cooling in cordierite bodies produced with those raw materials, but absent the glass-forming impurities. Thus, it is believed that subsequent heat treatment of a non-microcracked matrix can result in devitrification of the intergranular glass phase. Still further, it is also believed that the presence of strontium oxide can result in an increased nucleation density and thus the formation of smaller cordierite crystals or domains in the as fired ceramic body. The addition of rare-earth oxides as discussed above has been shown to be partially effective in stabilizing the glass against devitrification, however, such stabilization was only effective for intermediate temperatures and relatively short periods of time. According to the present disclosure, it has been found that the presence of strontium oxide in the residual glass phase can be effective in stabilization of the glass phase against devitrification. To that end, in some embodiments the porous cordierite ceramic honeycomb body comprises at least 1.0 wt % strontium oxide, more preferably at least 1.5 wt %, at least 2.0 wt %, and even at least 3.0 wt %.

It is also contemplated that the porous ceramic honeycomb body can, in addition to the primary cordierite phase, comprise one or more secondary ceramic phases, including for example one or more mullite, spinel, sapphirine, or corundum phases. However, in these embodiments, it can be desirable for the weight percentage of the secondary ceramic phase to be less than 10 wt %, or more preferably less than 5 wt. %, less than 4 wt. %, less than 3 wt. %, and even less than 2 wt. %, as measured by X-ray diffractometry. Higher amounts of these secondary crystalline phases can increase the CTE without substantially increasing the strain tolerance, thereby decreasing the overall thermal shock resistance of the honeycomb body.

To preserve good thermal shock resistance, the average coefficient of thermal expansion of the cordierite ceramic honeycomb body over the 25° C.-800° C. (hereinafter the CTE) should be relatively low. Accordingly, a CTE≦21.0×10⁻⁷/° C. along at least one direction in the ceramic body may be exhibited in embodiments of the disclosure. In embodiments, a CTE≦18.0×10⁻⁷/° C., a CTE≦16.0×10⁻⁷/° C., a CTE≦15.0×10⁻⁷/° C., or even a CTE≦14.0×10⁻⁷/° C. along at least one direction are provided. In embodiments of the low-microcracked honeycombs, the coefficient of thermal expansion of the cordierite ceramic honeycomb body along at least one direction over the temperature range can have a CTE≦12.0×10⁻⁷/° C., or even a CTE≦11.0×10⁻⁷/° C. In embodiments, a CTE in the range of about 10.5×10⁻⁷/° C. to about 18.0×10⁻⁷/° C. can be provided, including for example a CTE in the range of from about 10.5×10⁻⁷/° C. to about 14.0×10⁻⁷/° C.

The microcrack parameter Nb³ and the E-ratio E_{900° C.}/E_{25° C.} are measures of the level of microcracking in ceramic bodies, such as a cordierite ceramics. To that end, for a low-microcracked cordierite body, the elastic modulus gradually decreases with increasing temperature. This decrease in the elastic modulus is, without intending to be limited by theory, believed to be attributable to the increasing distance between atoms within the crystal structure with increasing temperature. The elastic modulus decrease has been found to be essentially linear from room temperature to 900° C., or even to 1000° C. Above about 1,000° C., there is a greater rate of decrease in elastic modulus with increasing temperature. This is believed to be due to the softening, or even partial melting, of a small amount of residual glass phase that originally formed by reaction of impurities or glass-forming metal oxide additions during sintering of the ceramic. Surprisingly, the rate of change in the elastic modulus with heating for a non-microcracked cordierite ceramic, ΔE° /ΔT, was found to be proportional to the value of the elastic modulus of the non-microcracked body at room temperature, E°_{25° C.}, and is closely approximated by the relation of EQ. 1:

ΔE°/ΔT=−7.5×10⁻⁵(E°_{25° C.}) EQ. 1

where the superscript “°” elastic modulus term (E°) denotes the elastic modulus of the ceramic in a non-microcracked state. For non-microcracked cordierite bodies, the temperature dependence of the elastic modulus during cooling after heating to a high temperature, such as 1,200° C., is essentially identical to the temperature dependence during the original heating, so that, at any given temperature, the value of the elastic modulus during cooling is nearly the same as its value at that temperature during heating. Based upon EQ. 1, one can calculate the ratio of the elastic modulus of a non-microcracked cordierite body at 900° C. to that of a non-microcracked cordierite body at 25° C. as being E°_{900° C.}/E°_{25° C.}=1+875(−7.5×10⁻⁵)=0.934.

In a highly microcracked ceramic body, the elastic modulus increases gradually, and then more steeply, with increasing temperature up to 1,200° C. This increase is believed to be due to the re-closing, and eventual annealing, of the microcracks with heating, so that the ceramic body has progressively fewer open microcracks at higher temperatures. The increase in E due to the reduction in microcracking more than offsets the decrease in E of the individual cordierite crystallites with heating, resulting in a more rigid body at high temperature. As the ceramic is cooled from 1,200° C., the microcracks do not immediately re-open, because micro-stresses are initially too low. As a result, the trend in elastic modulus with cooling is initially that of a non-microcracked cordierite body. The increase is steep at first due to the increase in viscosity of any liquid or glass phase, possibly accompanied by a reduction in volume fraction of the liquid or glass due to crystallization or devitrification, respectively.

The extent of microcracking in the cordierite ceramic can be reflected in two features of the elastic modulus heating and cooling curves. One manifestation of the degree of microcracking is the extent to which the elastic modulus increases from 25° C. to 900° C. during heating, as this increase is believed to be caused by a re-closing of the microcracks. Thus, the value of E_{900° C.}/E_{25° C.} for a cordierite ceramic may be utilized as a quantitative measure of the extent of microcracking in the room-temperature body.

According to embodiments of the disclosure E_{900° C.}/E_{25°}≦0.99, E_{900° C.}/E_{25° C.}≦0.98, E_{900° C.}/E_{25° C.}≦0.97, E_{900° C.}/E_{25° C.}≦0.96, E_{900° C.}/E_{25° C.}≦0.95, E_{900° C.}/E_{25° C.}≦0.94, and even E_{900° C.}/E_{25° C.}≦0.93. To that end, it should be noted that the minimum achievable value for E_{900° C.}/E_{25° C.} for a ceramic comprised of 100% cordierite is about 0.93 when the body is entirely absent of microcracks. When a glass phase is also present in the cordierite ceramic body, the value of E_{900° C.}/E_{25° C.} can be even less than 0.93 due to reduction in E_{900° C.} by softening of the glass at high temperature.

Another indication of the degree of microcracking is the gap between the elastic modulus heating and cooling curves. A method to quantify this hysteresis is based upon the construction of a tangent to the cooling curve in a temperature region where the sample is still in a non-microcracked state. The slope of the tangent line is, therefore, equivalent to the temperature dependence of the elastic modulus of the non-microcracked cordierite body, as constrained by EQ. 1. Furthermore, the value of this tangent line extrapolated back to room or ambient temperature is approximately equivalent to the room-temperature elastic modulus of the sample if it was not microcracked at room temperature, and is equal to E°_{° C.} for that sample. Thus, the equation of the tangent line is given by the following general expression of EQ. 2:

E°_{tangent}=(E°_{25° C.}){1−7.5×10⁻⁵(T−25)} EQ. 2

Where E°_{tangent} denotes the elastic modulus of the non-microcracked body at each temperature, T, along the tangent line.

An analytical method was devised for determining E°_{25° C.} from experimental measurements of the elastic modulus during cooling, after heating to about 1,200° C. In accordance with this method, a second-order polynomial is fit to the elastic modulus measurements made during cooling between about 1,000° C. and 500° C., as a function of temperature (° C.). This equation is of the following form:

E=c+b(T)+a(T²) EQ. 3

The upper limit of the temperature range over which the experimentally measured elastic modulus values are fit by EQ. 3 may be further restricted to a temperature less than 1000° C. if it is determined that the trend in E versus temperature exhibits a very high curvature at, or below, about 1000° C., due to, for example, the persistence of substantial softening of a glass phase or formation of a small amount of liquid below 1,000° C. Likewise, the lower limit of the temperature range over which the experimentally measured elastic modulus values are fit by EQ. 3 may be further restricted to a temperature greater than 500° C. if it is determined that the trend in E versus temperature exhibits a very high curvature at, or above, about 500° C., due to, for example, substantial reopening of the microcracks above 500° C. The method of least-squares regression analysis is used to derive the values of the regression coefficients “a,” “b,” and “c” in EQ. 3.

The value of E°_{25° C.} is obtained by solving for the elastic modulus and temperature at which the tangent line, given by EQ. 2, intersects the polynomial curve fit to the elastic modulus data during cooling, given by EQ. 2. The values of the elastic modulus and temperature at this point of intersection are denoted Eᵢ and Tᵢ, respectively. In the example in FIG. 2, the values of Eᵢ and Tᵢ correspond to the triangle, point C. Because this point of intersection is common to both the tangent line and the polynomial curve, it follows that

Eᵢ=(E°_{25° C.}){1−7.5×10⁻⁵(Tᵢ−25)}=c+b(Tᵢ)+a(Tᵢ²) EQ. 4

Also, at the point of tangency, the slope of the polynomial curve must equal that of the tangent line. Therefore, it follows that

(E°_{25° C.})(−7.5×10⁻⁵)=b+2a(Tᵢ) EQ. 5

EQ. 4 and EQ. 5 provide two equations relating the two unknown quantities, E°_{25° C.} and Tᵢ, to one another. To solve for E°_{25° C.} and Tᵢ, EQ. 5 is first rearranged to yield

(E°_{25° C.})={b+2a(Tᵢ)}/(−7.5×10⁻⁵) EQ. 6

EQ. 6 is then substituted into EQ. 4 to give the following expression:

{{b+2a(Tᵢ)}/(−7.5×10⁻⁵)}{1−7.5×10⁻⁵(Tᵢ−25)}=c+b(Tᵢ)+a(Tᵢ²) EQ. 7

EQ. 7 may be rearranged to yield the following:

0={c+b(Tᵢ)+a(Tᵢ²)}−{{b+2a(Tᵢ)}/(−7.5×10⁻⁵)}{1−7.5×10⁻⁵(Tᵢ−25)} EQ. 8

Gathering terms in EQ. 8 gives the following relation:

$$0 = \{ \begin{matrix}c - \{ \frac{b}{( - 7.5 \times {10}^{- 5} )} \} \\ \{ 1 + 7.5 \times {10}^{- 5} ( 25 ) \}\end{matrix} \} + ( {T}_{i} ) ( b ) - ( {T}_{i} ) \{ \frac{2 a}{( - 7.5 \times {10}^{- 5} )} \} \{ 1 + 7.5 \times {10}^{- 5} ( 25 ) \} - ( {T}_{i} ) \{ \begin{matrix}\{ \frac{b}{( 7.5 \times {10}^{- 5} )} \} \\ \{ - 7.5 \times {10}^{- 5} \}\end{matrix} \} + ( {T}_{i}^{2} ) \{ \begin{matrix}a - \{ \frac{2 a}{( - 7.5 \times {10}^{- 5} )} \} \\ ( - 7.5 \times {10}^{- 5} )\end{matrix} \} \qquad EQ . 9$$

Further simplifying EQ. 9 yields

$$0 = \{ \begin{matrix}c - \{ \frac{b}{( - 7.5 \times {10}^{- 5} )} \} \\ \{ 1 + 7.5 \times {10}^{- 5} ( 25 ) \}\end{matrix} \} + ( {T}_{i} ) \{ \frac{- 2 a}{( 7.5 \times {10}^{- 5} )} \} \{ 1 + 7.5 \times {10}^{- 5} ( 25 ) \} + ( {T}_{i}^{2} ) ( - a ) \qquad EQ . 10$$

EQ. 10 may be re-expressed as

0=C+B(Tᵢ)+A(Tᵢ²) EQ. 11

where C={c−{b/(−7.5×10⁻⁵)}{1+7.5×10⁻⁵(25)}}, B={−2a/(−7.5×10⁻⁵)}{1+7.5×10⁻⁵(25)}, and A=−a. The value of Tᵢ can then be found by solving the quadratic formula:

Tᵢ={−B+{B²−4(A)(C)}^{0.5}}/2A EQ. 12

Tᵢ={−B−{B²−4(A)(C)}^{0.5}}/2A EQ. 13

EQ. 12 and EQ. 13 provide two possible values of Tᵢ, of which only one will have a physically realistic value, that is, a value lying between 25 and 1,200° C. The physically realistic value of Tᵢ computed in this manner is then substituted into EQ. 6, from which the value of E°_{25° C.} is calculated.

Once E°_{25° C.} has been solved for, the ratio of the elastic modulus for the hypothetically non-microcracked sample at 25° C., E°_{25° C.}, to the actual measured value of the elastic modulus of the microcracked sample at 25° C., E_{25° C.} is proportional to the degree of microcracking in the initial sample before heating. That is, a greater degree of microcracking at room temperature will lower the value of E_{25° C.}, and thereby raise the value of E°_{25° C.}/E_{25° C.}.

Modeling of the relationship between elastic modulus and microcracking has provided a relationship between the ratio E°_{25° C.}/E_{25° C.} and the quantity Nb³, where N is the number of microcracks per unit volume of ceramic and b is the diameter of the microcracks (see D. P. H. Hasselman and J. P. Singh, “Analysis of the Thermal Stress Resistance of Microcracked Brittle Ceramics,” Am. Ceram. Soc. Bull., 58 (9) 856-60 (1979).) Specifically, this relationship may be expressed by the following equation:

Nb³ =( 9/16){(E°_{25° C.}/E_{25° C.})−1} EQ. 14

Although based upon a number of simplifying assumptions, the quantity Nb³, referred to herein as the “Microcrack Parameter,” provides another useful means to quantify the degree of microcracking in a ceramic body. For a non-microcracked body, the value of Nb³ is 0.00. In embodiments, it is therefore preferred that the value of Nb³ be ≦0.07. In embodiments, it is more preferred for the ceramic honeycomb bodies to exhibit microcrack parameters of Nb³≦0.06, Nb³≦0.05, Nb³≦0.04, Nb³≦0.03, Nb³≦0.02, or even Nb³≦0.01.

In addition to exhibiting the aforementioned microcrack properties in the as fired state, in embodiments the degree of microcracking remains stabile over prolonged exposure to conditions encountered during end use applications. To that end, in embodiments the degree of microcracking as characterized by the ratio E_{900° C.}/E_{25°} or as characterized by the microcrack parameter Nb³ remains stable after exposure to a temperature of at least about 850° C. for at least 80 hours in air. For example, after exposure to a temperature of at least about 850° C. for 80 hours in air embodiments of the disclosure can still exhibit an E_{900° C.}/E_{25°}≦0.99, E_{900° C.}/E_{25° C.}≦0.98, E_{900° C.}/E_{25° C.}≦0.97, E_{900° C.}/E_{25° C.}≦0.96, E_{900° C.}/E_{25° C.}≦0.95, E_{900° C.}/E_{25° C.}≦0.94, and even E_{900° C.}/E_{25° C.}≦0.93. Additionally or alternatively, after exposure to a temperature of at least about 850° C. for 80 hours in air, embodiments of the disclosure can still exhibit a microcrack parameter Nb³≦0.07, Nb³≦0.06, Nb³≦0.05, Nb³≦0.04, Nb³≦0.03, Nb³≦0.02, or even Nb³≦0.01.

Similary, in embodiments, the degree of microcracking as again characterized by the ratio E_{900° C.}/E_{25°} or as characterized by the microcrack parameter Nb³ remains stable after exposure to even higher temperatures of at least about 1100° C. for at least 2 hours in air. To that end, after exposure to a temperature of at least about 1100° C. for at least 2 hours in air, embodiments of the disclosure can still exhibit an E_{900° C.}/E_{25°}≦0.99, E_{900° C.}/E_{25° C.}≦0.98, E_{900° C.}/E_{25° C.}≦0.97, E_{900° C.}/E_{25° C.}≦0.96, E_{900° C.}/E_{25° C.}≦0.95, E_{900° C.}/E_{25° C.}≦0.94, and even E_{900° C.}/E_{25° C.}≦0.93. Additionally or alternatively, after the acidic treatment embodiments of the disclosure can also exhibit a microcrack parameter Nb³≦0.07, Nb³≦0.06, Nb³≦0.05, Nb³≦0.04, Nb³≦0.03, Nb³≦0.02, or even Nb³≦0.01.

In one embodiment, the porous ceramic honeycomb body comprises a primary cordierite ceramic phase, a porosity of at least 40% and a thermal shock parameter (MOR_{25° C.}/E_{25° C.})(CTE_{500-900° C.})⁻¹ of at least 450° C. and more preferably at least 650° C. Further, after exposure to a temperature of 1100° C. for at least 2 hours, the ceramic honeycomb body preferably exhibits at least one of a microcrack parameter Nb³ of not more than 0.07 and an elastic modulus ratio E_{900° C.}/E_{25° C.} during heating of not more than 0.99.

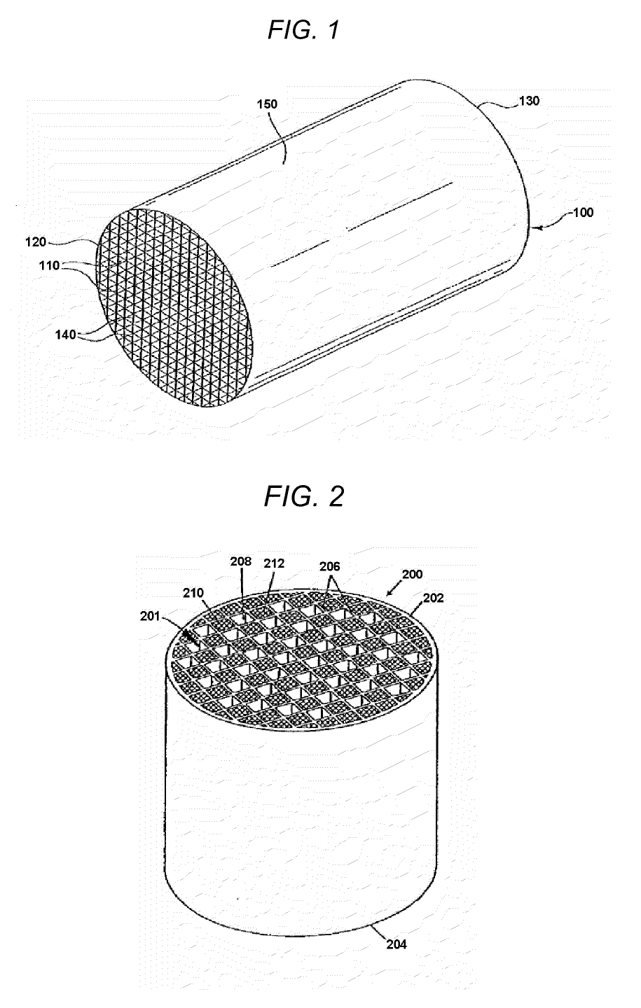

The porous cordierite ceramic honeycomb bodies comprise a plurality of cell channels extending between a first and second end as shown for example in FIG. 1. The ceramic honeycomb body may have a honeycomb structure that may be suitable for use as, for example, flow-through catalyst substrates or wall-flow exhaust gas particulate filters, such as diesel particulate filters. A typical porous ceramic honeycomb flow-through substrate article 100 according to embodiments of the disclosure is shown in FIG. 1 and includes a plurality of generally parallel cell channels 110 formed by and at least partially defined by intersecting cell walls 140 (otherwise referred to as “webs”) that extend from a first end 120 to a second end 130. The channels 110 are unplugged and flow through them is straight down the channel from first end 120 to second end 130. In one embodiment, the honeycomb article 100 also includes an extruded smooth skin 150 formed about the honeycomb structure, although this is optional and may be formed in later processing as an after applied skin. In embodiments, the wall thickness of each cell wall 140 for the substrate can be, for example, between about 0.002 to about 0.010 inches (about 51 to about 254 μm). The cell density can be, for example from about 300 to about 900 cells per square inch (cpsi). In one implementation, the cellular honeycomb structure can consist of multiplicity of parallel cell channels 110 of generally square cross section formed into a honeycomb structure. Alternatively, other cross-sectional configurations may be used in the honeycomb structure as well, including rectangular, round, oblong, triangular, octagonal, hexagonal, or combinations thereof. “Honeycomb” refers to a connected structure of longitudinally-extending cells formed of cell walls, having a generally repeating pattern therein.

FIG. 2 illustrates an exemplary honeycomb wall flow filter 200 according to embodiments of the disclosure. The general structure includes a body 201 made of intersecting porous ceramic walls 206 extending from the first end 202 to the second end 204. Certain cells are designated as inlet cells 208 and certain other cells are designated as outlet cells 210. In the filter 200, certain selected channels include plugs 212. Generally, the plugs are arranged at the ends of the channels and in some defined pattern, such as the checkerboard patterns shown. The inlet channels 208 may be plugged at the outlet end 204 and the outlet channels 210 may be plugged at the inlet end 202. Other plugging patterns may be employed and all of the outermost peripheral cells may be plugged (as shown) for additional strength. Alternately, some of the cells may be plugged other than at the ends. In embodiments, some channels can be flow-through channels and some can be plugged providing a so-called partial filtration design. In embodiments, the wall thickness of each cell wall for the filter can be for example from about 0.006 to about 0.030 inches (about 152 to about 762 μm). The cell density can be for example between 100 and 400 cells per square inch (cpsi).

References to cordierite ceramic bodies or honeycombs refer to cordierite compositions comprised predominately of Mg₂Al₄Si₅O₁₈. However, the cordierite bodies can also contain compositions of similar physical properties, for example, “stuffed” cordierite compositions. Stuffed cordierites are cordierites having molecules or elements such as H₂O, CO₂, Li, K, Na, Rb, Cs, Ca, Sr, Ba, Y, or a lanthanide element in the channel site of the cordierite crystal lattice. Such constituents can impart modified properties, such as improved sinterability or reduced lattice thermal expansion or thermal expansion anisotropy, which may be useful for some applications. Also included are cordierites having chemical substitutions of, for example, Fe, Mn, Co, Ni, Zn, Ga, Ge, or like elements, for the basic cordierite constituents to provide, for example, improved sinterability, color, electrical properties, catalytic properties, or like properties. The symmetry of the crystal lattice of the cordierite phase can be, for example, orthorhombic, hexagonal, or any mixture of phases having these two symmetries.

In embodiments, the disclosure also provides batch compositions and methods for making the porous cordierite ceramic honeycomb structures described above, where a plasticized ceramic forming precursor batch composition is provided by compounding an inorganic powder batch mixture together with an organic binder; and a liquid vehicle. The plasticized batch can further comprise one or more optional constituents including pore-forming agents, plasticizers, and lubricants. The plasticized batch is then formed by shaping, such as by extrusion, into a green honeycomb. These green honeycombs are then dried, such as by microwave or RF drying, and fired in a kiln for a time and at a temperature sufficient to sinter or reaction-sinter the inorganic raw material sources into unitary cordierite ceramic honeycomb bodies. The sintered ceramic honeycomb bodies exhibit relatively low microcracking and relatively high thermal shock resistance as described above.

The batch composition for forming the porous ceramic honeycomb bodies disclosed herein comprise a mixture of raw cordierite forming components that can be heated under conditions effective to provide a primary sintered phase cordierite composition. The raw cordierite forming batch components can include, for example, a magnesium source; an aluminum source; and a silicon source. As an example the inorganic ceramic powder batch composition can be selected to provide a cordierite composition consisting essentially of from about 49 to about 53 percent by weight SiO₂, from about 33 to about 38 percent by weight Al₂O₃, and from about 12 to about 16 percent by weight MgO.

A “magnesium source” is any compound that contains magnesium, such as, for example, talc, calcined talc, chlorite, forsterite, enstatite, actinolite, serpentine, spinel, sapphirine, or a magnesium oxide forming source, etc. A magnesium oxide forming source is any magnesium source which, upon heating, converts to magnesium oxide, MgO, such as, for example, magnesium oxide, magnesium hydroxide, magnesium carbonate, and the like. In one embodiment, the magnesium source is a talc component.

When the magnesium sources comprises talc, it is preferred that the talc have a platy particle morphology, such that the talc has an XRD talc morphology index of between 0.6 and 1.0. Talc having a very platy morphology will have a high morphology index. The talc morphology index is more preferably at least 0.85, because talc with a platy particle shape promotes the growth of cordierite crystals with their negative-expansion c-axes in the plane of the wall, thereby lowering CTE in the axial and radial directions of the honeycomb article. The value of the XRD talc morphology index can range from 0.0 to 1.0 and is proportional to the aspect ratio, or platy character, of the talc particles. The talc morphology index is measured by x-ray diffractometry on a talc powder that is packed into the x-ray diffraction sample holder to maximize the orientation of the talc within the plane of the sample holder, as described in U.S. Pat. No. 5,258,150. The XRD talc morphology index, M, is defined by the relationship:

M=I(004)/[I(004)+I(020)] EQ. 15

where I(004) and I(020) are the x-ray intensities of the (004) and (020) reflections as measured by Cu Kα radiation. When the talc is provided as a calcined talc, the morphology index shall refer to that of the talc powder prior to being calcined.

According to some embodiments, the talc has a median particle size less than about 15 μm, or even less than about 10 μm. Particle size is measured by, for example, a laser diffraction technique, such as by a Microtrac® particle size analyzer. Examples of suitable commercially available talc for use in the present disclosure include, FCOR Talc and Jetfil 500 talc, both available from Luzenac, Inc. of Oakville, Ontario, Canada.

An “aluminum” source is any compound that contains aluminum, such as an alumina forming source, kaolin, calcined kaolin, pyrophyllite, kyanite, mullite, sillimanite, andalusite, magnesium aluminate spinel, sapphirine, chlorite, etc. An alumina forming source is a compound that converts to aluminum oxide, Al₂O₃, upon heating, such as corundum; a transitional alumina such as gamma, theta, chi, and rho alumina; aluminum hydroxide, also known as aluminum trihydrate or Gibbsite; or an aluminum oxide hydroxide such as boehmite or diaspore. An alumina forming source, if present, preferably has a median particle diameter of less than 15 μm, and more preferably less than 10 μm. In still further embodiments, the median particle size of the alumina forming source is preferably less than 8 μm, including for example, median particle sizes less than 7 μm, less than 6 μm, less than 5, less than 4, less than 3, less than 2, or even less than 1 μm. Commercially available aluminum sources can include the A3000 available from Alcoa and HVA Alumina available from Almatis.

If desired, the aluminum source can include a dispersible alumina forming source. A dispersible alumina forming source can be an alumina forming source that is at least substantially dispersible in a solvent or liquid medium and that can be used to provide a colloidal suspension in a solvent or liquid medium. In embodiments, a dispersible alumina forming source can be a relatively high surface area alumina forming source having a specific surface area of at least 20 m²/g. Alternatively, a dispersible alumina forming source can have a specific surface area of at least 50 m²/g. In an exemplary embodiment, a suitable dispersible alumina forming source for use in the methods of the disclosure includes alpha aluminum oxide hydroxide (AlOOH.xH₂O) commonly referred to as boehmite, pseudoboehmite, and as aluminum monohydrate. In exemplary embodiments, the dispersible alumina forming source can include the so-called transition or activated aluminas (i.e., aluminum oxyhydroxide and chi, eta, rho, iota, kappa, gamma, delta, and theta alumina) which can contain various amounts of chemically bound water or hydroxyl functionalities. Specific examples of commercially available dispersible alumina forming sources that can be used in the disclosure include Dispal 18N4-80, commercially available from Sasol North America.

A “silicon source” is any compound that contains silicon, including, for example, kaolin, calcined kaolin, mullite, kyanite, sillimanite, andalusite, pyrophyllite, talc, calcined talc, chlorite, sapphirine, forsterite, enstatite, sapphirine, zeolite, diatomaceous silica, or a silica forming source. In embodiments, the silicon source can preferably have a median particle diameter less than 15 microns, or even more preferably less than 10 microns. Exemplary kaolin clays include, for example, non-delaminated kaolin raw clay, having a particle size of about 7-9 microns, and a surface area of about 5-7 m²/g, such as Hydrite MP™ and those having a particle size of about 2-5 microns, and a surface area of about 10-14 m²/g, such as Hydrite PX™ and delaminated kaolin having a particle size of about 1-3 microns, and a surface area of about 13-17 m²/g, such as KAOPAQUE-10™ or calcined kaolin, having a median particle size of about 1-3 microns, and a surface area of about 6-8 m²/g, such as Glomax LL. All of the above named materials are available from Imerys Minerals, Ltd.

A silica forming source is any compound that forms silica, SiO₂, upon heating. For example, a silica forming source can be quartz, cristobalite, tridymite, tripoli silica, flint, fused silica, colloidal or other amorphous silica, etc. In some embodiments, the silica forming source is crystalline silica such as quartz or cristobalite. In alternative embodiments, the silica forming source is non-crystalline silica such as fused silica or sol-gel silica, silicone resin, zeolite, diatomaceous silica, and like materials. A commercially available quartz silica forming source can include, for example, Imsil A25 Silica available from Unimin Corporation. In still further embodiments, the silica forming source can include a compound that forms free silica when heated, such as for example, silicic acid or a silicon organo-metallic compound.

The batch composition may optionally contain a source of metal oxides other than MgO, Al₂O₃, and SiO₂, which partition into a liquid phase during sintering and which contribute to the presence of a secondary glass phase after cooling. As noted previously, the presence of a glass phase has been found to further reduce the microcrack index of the cordierite ceramic honeycomb body and also may provide a narrower pore size distribution. Alternatively, the glass-forming metal oxide source may be added as a colloidal suspension or even as a liquid solution of the metal oxide forming salt. When the metal oxide sources include lithium, sodium, potassium, calcium, titanium, or iron, the glass forming metal oxide containing source may include a dispersible silicate of fine particle size (e.g., <1 μm) such as a smectite, laponite, attapulgite, hectorite, bentonite, montmorillonite, ball clay, or other natural silicate containing the desired metal oxide as a component of their chemistry. In some embodiments, an exemplary dispersible silicates that can be used includes Bentonite clay. In alternative embodiments, the dispersible silicate can be a magnesium alumino silicate such as Acti-gel™ 208 available from Active Minerals International, LLC.

The glass forming metal oxide source may also include metal oxides selected from the group consisting of a rare earth oxide, strontium oxide, barium oxide, and zinc oxide. As noted above, it has been found that the presence of strontium oxide in the residual glass phase can be effective in stabilization of the glass phase against devitrification. According to embodiments, the batch composition preferably comprises a strontium oxide source in an amount sufficient to provide at least 1.0 weight %, and more preferably from 1.0 weight % to 3.0 weight % strontium oxide in the as fired body. An exemplary strontium oxide source that can be used in the disclosed batch compositions is strontium carbonate.

According to some embodiments, the plasticized batch composition can comprise at least 10 wt % pore forming agent, and preferably at least 20%, at least 40%, and even at least 50% pore-forming agent. The weight percent of the pore forming agent is calculated as a super-addition to the oxide-forming inorganic raw materials. Thus, for example, the addition of 50 parts by weight of a pore forming agent to 100 parts by weight of oxide forming raw materials shall constitute 50% addition of pore forming agent. The pore-forming agents can include, for example, graphite, flour, starch, or even combinations thereof. The starch can include, for example corn, rice, or potato starch. The flour can include walnut shell flour. The median particle diameter of the pore forming agent is selected according to the application of the ceramic honeycomb, and in some embodiments is preferably between 1 and 60 microns.

To provide a plasticized batch composition, the inorganic powder batch composition, including the aforementioned powdered ceramic materials, the glass forming metal oxide source, and any pore former, can be compounded with a liquid vehicle, an organic binder, and one or more optional forming or processing aids. Exemplary processing aids or additives can include lubricants, surfactants, plasticizers, and sintering aids. Exemplary lubricants can include hydrocarbon oil, tall oil, or sodium stearate. An exemplary commercially available lubricant includes Liga GS, available from Peter Greven Fett-Chemie.

The organic binder component can include water soluble cellulose ether binders such as methylcellulose, hydroxypropyl methylcellulose, methylcellulose derivatives, or a combination thereof. Particularly preferred examples include methylcellulose and hydroxypropyl methylcellulose. Preferably, the organic binder can be present in the composition as a super addition in an amount in the range of from 0.1 weight percent to 8.0 weight percent of the inorganic powder batch composition, and more preferably, in an amount of from about 3 weight percent to about 6 weight percent of the inorganic powder batch composition. The incorporation of the organic binder into the batch composition can further contribute to the cohesion and plasticity of the composition. The improved cohesion and plasticity can, for example, improve the ability to shape the mixture into a honeycomb body.

A preferred liquid vehicle for providing a flowable or paste-like consistency to the inventive compositions is water, although other liquid vehicles exhibiting solvent action with respect to suitable temporary organic binders can be used. The amount of the liquid vehicle component can vary in order to impart optimum handling properties and compatibility with the other components in the ceramic batch mixture. Preferably, the liquid vehicle content is present as a super addition in an amount in the range of from 15% to 60% by weight of the inorganic powder batch composition, and more preferably in the range of from 20% to 40% by weight of the inorganic powder batch composition. Minimization of liquid components in the disclosed compositions can lead to further reductions in undesired drying shrinkage and crack formation during the drying process.

The honeycomb substrate such as that depicted in FIG. 1 can be formed from the plasticized batch according to any conventional process suitable for forming honeycomb monolith bodies. For example, in embodiments a plasticized batch composition can be shaped into a green body by any known conventional ceramic forming process, such as, e.g., extrusion, injection molding, slip casting, centrifugal casting, pressure casting, dry pressing, and the like. In embodiments, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die.

The resulting honeycomb body can then be dried, and subsequently fired under conditions effective to convert the formed green composition into a primary sintered phase ceramic composition. Conditions effective for drying the formed green body functionally can include those conditions capable of removing at least substantially all of the liquid vehicle present within the green composition. As used herein, at least substantially all include the removal of at least about 95%, at least about 98%, at least about 99%, or even at least about 99.9% of the liquid vehicle present prior to drying. Exemplary and non-limiting drying conditions suitable for removing the liquid vehicle include heating the green honeycomb substrate at a temperature of at least about 50° C., at least about 60° C., at least about 70° C., at least about 80° C., at least about 90° C., at least about 100° C., at least about 110° C., at least about 120° C., at least about 130° C., at least about 140° C., or even at least about 150° C. for a period of time sufficient to at least substantially remove the liquid vehicle from the green composition. In embodiments, the conditions effective to at least substantially remove the liquid vehicle comprise heating the formed green body at a temperature of at least about 60° C. Further, the heating can be provided by any conventionally known method, including for example, hot air drying, RF, microwave drying, or a combination thereof.

With reference again to FIG. 2, either before or after the green body has been fired, a portion of the cells 210 of a formed monolithic honeycomb 200 can be plugged at the inlet end 202 with a paste having the same or similar composition to that of the body 201. The plugging is preferably performed only at the ends of the cells and form plugs 212 having a depth of about 5 to 20 mm, although this can vary. A portion of the cells on the outlet end 204 but not corresponding to those on the inlet end 202 may also be plugged in a similar pattern. Therefore, each cell is preferably plugged only at one end. The preferred arrangement is to therefore have every other cell on a given face plugged as in a checkered pattern as shown in FIG. 2. Further, the inlet and outlet channels can be any desired shape. However, in the exemplified embodiment shown in FIG. 2, the cell channels are square in cross-sectional shape.

The formed honeycomb bodies can then be fired under conditions effective to convert the inorganic powder batch composition into a primary sintered phase cordierite composition. Exemplary firing conditions can comprise heating the honeycomb green body at a maximum firing temperature in the range of from about 1360 to 1440° C. for 4 to 40 hours to form a body with at least 80% cordierite. The total time from room temperature till the end of the hold at maximum temperature is preferably at least 25 hours.

### EXAMPLES

To further illustrate the principles of the disclosure, the following examples provide those of ordinary skill in the art with a complete disclosure and description of how the cordierite honeycomb bodies and methods claimed herein are made and evaluated. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

Table 1 provides the batch compositions for one comparative example (C1) and one inventive example (I1) which were prepared and used to form experimental honeycomb bodies for evaluation of various performance characteristics. Comparative example C1 represents an exemplary batch composition absent of any residual glass phase stabilization. Inventive batch composition I1 represents an exemplary batch composition of the present disclosure comprising strontium carbonate as a strontium oxide source for microcrack stabilization.

TABLE 1
Batch Compositions

Batch Composition

| | C1 | I1 |
|---|---|---|
| Luzenac FCOR Talc | 42.38 | 42.38 |
| HVA Alumina | — | — |
| Imsil A25 | 23.50 | 23.50 |
| Jetfil 500 | — | — |
| Alcoa A3000 Alumina | 30.12 | 30.12 |
| Acti-gel 208 | 2.50 | — |
| Bentonite CH235 | — | 2.50 |
| Dispal 18N4-80 | 5.00 | 5.00 |
| Yttrium Oxide Grade C | — | — |
| Strontium Carbonate | — | 1.5 |
| Walnut Shell Flour-325 | 40.00 | 40.00 |
| F240 Methocel | 6.00 | 6.00 |
| Liga | 1.00 | 1.00 |

In preparing the examples, inorganic raw materials and pore formers were mixed with 6% methylcellulose binder and 1% of a sodium stearate lubricant, and water was added to the powder mixture in a stainless steel muller to form a plasticized batch. The two batches were extruded as honeycombs with a cell density of approximately 300 cpsi (cells per square inch), and partition walls 8 mils in thickness. The honeycomb parts were dried and fired to 1400° C. for 8 hrs. Fired parts were heated treated to 850° C. for 82 hours and 1100° C. for 2 hours to determine the effect of heat treatment on level of microcracking. Property changes are shown in Table 2.

TABLE 2
Properties of As-Fired Honeycomb Bodies

| | Batch Composition | | | | | |
|---|---|---|---|---|---|---|
| | C1 | | | I1 | | |
| | As-fired | 850° C. | 1100° C. | As-fired | 850° C. | 1100° C. |
| CTE (RT-800° C.) | 10.0 | 9.1 | 9.9 | 17.9 | 17.7 | 14.7 |
| CTE (500-900° C.) | 17.0 | 15.7 | 16.7 | 23.7 | 23.9 | 21.6 |
| MOR (psi) | 559 | 356 | 346 | 839 | 826 | 668 |
| E-Mod (RT) | 3.54E+05 | 3.83E+05 | 3.41E+05 | 4.56E+05 | 4.42E+05 | 4.58E+05 |
| E-Mod (500° C.) | 4.15E+05 | 3.98E+05 | 3.89E+05 | 4.43E+05 | 4.31E+05 | 4.42E+05 |
| E-Mod (900° C.) | 4.13E+05 | 4.06E+05 | 4.19E+05 | 4.16E+05 | 4.04E+05 | 4.18E+05 |
| Eᵣₐₜᵢₒ (E_{900° C.}/E_{25° C.}) | 1.17 | 1.06 | 1.23 | 0.91 | 0.91 | 0.91 |
| Nb³ | 0.047 | 0.105 | 0.093 | 0.015 | 0.02 | 0.017 |
| Strain Tolerance (RT) | 0.16 | 0.09 | 0.10 | 0.18 | 0.19 | 0.15 |
| Strain Tolerance (500° C.) | 0.13 | 0.09 | 0.09 | 0.19 | 0.19 | 0.15 |
| TSP | 792 | 570 | 533 | 799 | 802 | 700 |
| TSL | 1292 | 1070 | 1033 | 1299 | 1302 | 1200 |

Table 2 shows as-fired and heat treated physical properties for the three batch compositions shown in Table 1. All properties were measured on fired honeycomb specimens. The mean coefficients of thermal expansion from 25 to 800° C. and from 500 to 900° C., in units of 10⁻⁷/° C., were measured by dilatometry on a specimen parallel to the lengths of the channels of the honeycomb article (“axial direction”). The thermal shock parameter, TSP, was computed as (MOR_{25° C.}/E_{25° C.})(CTE_{500-900° C.})⁻¹, as defined previously. Also calculated was the corresponding thermal shock limit, TSL=TSP+500° C. The value of TSL provides an estimate of the maximum temperature that the ceramic honeycomb article can withstand when the coolest region elsewhere in the part is at about 500° C. All modulus of rupture (MOR), or flexural strength, values were measured by the four-point method on a cellular bar (0.5 inch×0.25 inch×2.75 inches long) parallel to the axial direction of the honeycomb. Elastic modulus values were measured by a sonic resonance technique either on a cellular bar (1 inch×0.5 inch×5 inches long) parallel to the axial direction, or on a non-cellular rod.

For some examples, as-fired rod or honeycomb specimens were heated in air to a temperature of 850° C., held at 850° C. for 82 hours, and cooled to room temperature. Also, as-fired rod or honeycomb specimens for some examples were heated to 1100° C., held at 1100° C. for 2 hours, and cooled to room temperature. The microcrack parameter Nb³ was subsequently measured on these treated samples.

As indicated by the data in Table 2, the unstabilized batch composition C1 resulted in a honeycomb body which, after heat-treating to 850° C. for 82 hours exhibited a relatively high microcrack parameter value of Nb³. In addition, a decrease in strength (as measured by MOR) and CTE further indicate an increase in microcrack density compared to the as-fired state. Although a relatively low density of microcracks can be seen in the as-fired sample, after both heat treatments, the Nb³ value increases significantly. In contrast, the inventive batch composition I1, comprising strontium carbonate as a source of strontium oxide, shows relatively little change in Nb³ after either heat treatment.

The disclosure has been described with reference to various specific embodiments and techniques. However, many variations and modifications are possible while remaining within the spirit and scope of the disclosure.

What is claimed is:

1. A porous ceramic honeycomb body, comprising:
a primary cordierite ceramic phase;
a total porosity % P of at least 40%; and
a thermal shock parameter (TSP) of at least 450° C., wherein TSP is (MOR_{25° C.}/E_{25° C.})(CTE_{500-900° C.})⁻¹, MOR_{25° C.} is the modulus of rupture strength at 25° C., E_{25° C.} is the Young's elastic modulus at 25° C., and CTE_{500-900° C.} is the high temperature thermal expansion coefficient at 500° C. to 900° C.;
wherein after exposure to a temperature of 1100° C. for at least 2 hours, the honeycomb body exhibits at least one of:
an elastic modulus ratio Eᵣₐₜᵢₒ of not more than 0.99, wherein Eᵣₐₜᵢₒ=E_{900° C.}/E_{25° C.} where E_{900° C.} is the elastic modulus at 900° C. measured during heating, and
a microcrack parameter Nb³ that is not greater than 0.07.

2. The porous ceramic honeycomb body of claim 1, wherein the total porosity % P is at least 50%.

3. The porous ceramic honeycomb body of claim 1, wherein the thermal shock parameter is at least 650° C.

4. The porous ceramic honeycomb body of claim 1, wherein after exposure to a temperature of 850° C. for at least 80 hours the honeycomb body exhibits at least one of:
an elastic modulus ratio Eᵣₐₜᵢₒ of not more than 0.99, and
a microcrack parameter Nb³ that is not greater than 0.07.

5. The porous ceramic honeycomb body of claim 1, further exhibiting a coefficient of thermal expansion CTE_{25-800° C.} less than 24.0×10⁻⁷/° C.

6. The porous ceramic honeycomb body of claim 1, further comprising a strain tolerance of at least 0.14×10⁻² where the strain tolerance=(MOR_{25° C.}/E_{25° C.}).

7. The porous ceramic honeycomb body of claim 1, further comprising a secondary glass phase.

8. A batch composition for forming a porous ceramic honeycomb body, comprising:
a cordierite forming inorganic powder batch mixture comprising:
a magnesium source;
an aluminum source;
a silicon source; and
a strontium oxide source;
an organic binder; and
a liquid vehicle.

9. The batch composition of claim 8, wherein the strontium oxide source is comprised of strontium carbonate.

10. The batch composition of claim 8, wherein the strontium oxide source is present in an amount of at least 0.25 weight percent of the inorganic powder batch mixture.

11. The batch composition of claim 10, wherein the strontium oxide source is present in an amount in the range of from 0.25 to 3.0 weight percent of the inorganic powder batch mixture.

12. The batch composition of claim 8, further comprising a pore forming agent.

13. The batch composition of claim 8, wherein the batch composition can be fired to provide a porous ceramic body comprising
a primary cordierite ceramic phase;
a total porosity % P of at least 40%;
a thermal shock parameter (TSP) of at least 450° C., wherein TSP is (MOR_{25° C.}/E_{25° C.})(CTE_{500-900° C.})⁻¹, MOR_{25° C.} is the modulus of rupture strength at 25° C., E_{25° C.} is the Young's elastic modulus at 25° C., and CTE_{500-900° C.} is the high temperature thermal expansion coefficient at 500° C. to 900° C.;
an elastic modulus ratio Eᵣₐₜᵢₒ of not more than 0.99, wherein Eᵣₐₜᵢₒ=E_{900° C.}/E_{25° C.} where E_{900° C.} is the elastic modulus at 900° C. measured during heating, and
a microcrack parameter Nb³ that is not greater than 0.07.

14. The batch composition of claim 8, wherein the magnesium source is comprised of talc.

15. A method for making a porous ceramic honeycomb body, the method comprising:
providing a plasticized ceramic forming precursor batch composition, comprising:
a cordierite forming inorganic powder batch mixture comprising:
talc; an aluminum source; a silicon source; and a strontium oxide source;
an organic binder; and
a liquid vehicle;
forming a honeycomb green body from the plasticized ceramic forming precursor batch composition; and
firing the honeycomb green body under conditions effective to form a porous ceramic honeycomb body comprising:
a primary cordierite ceramic phase;
a total porosity % P of at least 40%; and
a thermal shock parameter (TSP) of at least 450° C., wherein TSP is (MOR_{25° C.}/E_{25° C.})(CTE_{500-900° C.})⁻¹, MOR_{25° C.} is the modulus of rupture strength at 25° C., E_{25° C.} is the Young's elastic modulus at 25° C., and CTE_{500-900° C.} is the high temperature thermal expansion coefficient at 500° C. to 900° C.

16. The method of claim 15, wherein the strontium oxide source is comprised of strontium carbonate.

17. The method of claim 15, wherein the strontium oxide source is present in an amount of at least 0.25 weight percent of the inorganic powder batch mixture.

18. The method of claim 15, wherein the strontium oxide source is present in an amount in the range of from 0.25 to 3.0 weight percent of the inorganic powder batch mixture.

19. The method of claim 15, wherein the plasticized ceramic forming precursor batch composition further comprises a pore forming agent.
